(19) United States
(12) Patent Application Publication
(10) Pub. No.: US 2024/0086568 A1
(43) Pub. Date: Mar. 14, 2024

(54) Privacy Preserving System And Method For Software As A Service Platforms

(71) Applicant: Google LLC, Mountain View, CA (US)

(72) Inventors: Lukas Alexander Fleischer, Waterloo (CA); Geoff Oitment, West Montrose (CA); Jia Herr Tee, Kitchener (CA); Zigmars Rasscevskis, Zürich (CH); Kaveh Ghasemloo, Toronto (CA); Grant Davis, Ariss (CA); Nirmal Veerasamy, Waterloo (CA); Katherine K. Sheridan-Barbian Ortiz, Greenwich, CT (US); Matthew Ichinose, Washington, DC (US); Vinsensius B. Vega S. Naryanto, Zürich (CH)

(21) Appl. No.: 17/942,258

(22) Filed: Sep. 12, 2022

(51) Int. Cl. G06F 21/62

(52) U.S. Cl. CPC G06F 21/6245; G06F 21/6227

(57) ABSTRACT

Aspects of the disclosure are directed to protecting non-public data used in computer-based trials. Reports can be generated based on the computer-based trials that contain performance metrics or other data points to evaluate the computer-based trials. The reports can be viewed by data providers and/or trial providers without divulging the non-public data. Data providers can provide the non-public data for running the computer-based trials. Trial providers can run the computer-based trials. A cloud provider can provide infrastructure for storing source code for the computer-based trials, the non-public data, and reports generated from the computer-based trials. The cloud provider can also provide infrastructure for executing the computer-based trials and generating the reports from the computer-based trials.

### BACKGROUND

Software as a service (SaaS) platforms can conduct computer-based trials to improve their services. However, these computer-based trials can require real-world data from users of the SaaS platforms, as synthetic data can be insufficient for generating accurate results from the computer-based trials. Since real-world data can include non-public data, users of the SaaS platforms can be hesitant to provide that data for use in the computer-based trials.

### BRIEF SUMMARY

Aspects of the disclosure are directed to protecting non-public data provided by data providers to be used for computer-based trials by trial providers. The trial providers would not have direct access to the non-public data provided by the data providers. Reports can be generated containing metrics and/or other data points to evaluate the computer-based trials. The data providers can view and give feedback based on the generated reports from the computer-based trials. The trial providers can also view the generated reports.

An aspect of the disclosure provides for a method for protecting data in computer-based trials. The method includes receiving from a data provider, with one or more processors of a cloud provider, a dataset marked as available for the computer-based trials; performing by a trial provider, with the one or more processors, one or more computer-based trials using the dataset in a compute environment that is isolated from the trial provider and the data provider; generating, with the one or more processors, one or more reports based on the performed computer-based trials to evaluate the computer-based trials; and storing, with the one or more processors, the one or more reports in a secure storage that is inaccessible to the trial provider and the data provider, wherein access to the data by the cloud provider is verified by at least one of the trial provider or the data provider.

In an example, the method further includes deleting, with the one or more processors, the one or more reports from the secure storage within a period of time when the dataset marked as available for the computer-based trials is deleted.

In another example, the method further includes automatically redacting, with the one or more processors, data in the dataset to generate a redacted dataset, where the one or more computer-based trials are performed using the redacted dataset to generate the reports. In yet another example, the redacted dataset includes at least one of irreversible mapping of fields of the dataset to random values or bucketizing fields of the dataset. In yet another example, the redacted dataset is a new copy of the dataset marked as available for the computer-based trials.

In yet another example, performing the one or more computer-based trials further includes running a machine learning pipeline for a training run or a validation run.

In yet another example, the method further includes logging, with the one or more processors, each view of the one or more reports by the data provider or the trial provider. In yet another example, logging each view of the one or more reports further includes generating an access log for at least one of the data provider or the trial provider.

Another aspect of the disclosure provides for a system including one or more processors; and one or more storage devices coupled to the one or more processors and storing instructions that, when executed by the one or more processors, cause the one or more processors to perform operations for protecting data in computer-based trials. The operations include receiving a dataset marked as available for the computer-based trials; performing one or more computer-based trials using the dataset in an isolated compute environment; generating one or more reports based on the performed computer-based trials to evaluate the computer-based trials; and storing the one or more reports in a secure storage, wherein access to the secure storage is verifiable.

In an example, the operations further include deleting the one or more reports from the secure storage within a period of time when the dataset marked as available for the computer-based trials is deleted.

In another example, the operations further include automatically redacting data in the dataset to generate a redacted dataset, where the one or more computer-based trials are performed using the redacted dataset to generate the reports. In yet another example, the redacted dataset is a new copy of the dataset marked as available for the computer-based trials.

In yet another example, performing the one or more computer-based trials further includes running a machine learning pipeline for a training run or a validation run.

In yet another example, the operations further include logging each view of the one or more reports. In yet another example, logging each view of the one or more reports further includes generating an access log.

Yet another aspect of the disclosure provides for a non-transitory computer readable medium for storing instructions that, when executed by one or more processors, cause the one or more processors to perform operations for protecting data in computer-based trials. The operations include receiving a dataset marked as available for the computer-based trials; performing one or more computer-based trials using the dataset in an isolated compute environment; generating one or more reports based on the performed computer-based trials to evaluate the computer-based trials; and storing the one or more reports in a secure storage, wherein access to the secure storage is verifiable.

In an example, the operations further include deleting the one or more reports from the secure storage within a period of time when the dataset marked as available for the computer-based trials is deleted.

In another example, the operations further include automatically redacting data in the dataset to generate a redacted dataset, where the one or more computer-based trials are performed using the redacted dataset to generate the reports.

In yet another example, performing the one or more computer-based trials further includes running a machine learning pipeline for a training run or a validation run.

In yet another example, the operations further include logging each view of the one or more reports by generating an access log.

### BRIEF DESCRIPTION OF THE DRAWINGS

FIG. 1 depicts a block diagram of an example infrastructure for protecting non-public data in computer-based trials according to aspects of the disclosure.

FIG. 2 depicts a block diagram further detailing an example infrastructure for the data provider environment, trial provider environment, and computer-based trial environment of the cloud provider according to aspects of the disclosure.

FIG. 3 depicts a flow diagram of an example process for protecting non-public data in computer-based trials according to aspects of the disclosure.

FIG. 4 depicts a block diagram of an example environment for implementing a system for protecting non-public data in computer-based trials according to aspects of the disclosure.

### DETAILED DESCRIPTION

Generally disclosed herein are implementations for protecting non-public data in computer-based trials. Computer-based trials can include running and/or testing a machine learning model or running and/or testing an algorithm. Reports can be generated based on the computer-based trials that contain performance metrics or other data points to evaluate the computer-based trials. The reports can be viewed by data providers and/or trial providers without divulging the non-public data. Data providers can provide the non-public data for running the computer-based trials. Trial providers can run the computer-based trials using the non-public data. A cloud provider can provide infrastructure for storing source code for the computer-based trials, the non-public data, and reports generated from the computer-based trials. The cloud provider can also provide infrastructure for executing the computer-based trials and generating the reports from the computer-based trials.

A list of datasets marked as available for computer-based trials are received from the data provider through the infrastructure provided by the cloud provider. The datasets can include the non-public data, such as PII data. The data provider can automatically update the datasets periodically. The computer-based trials are performed using the dataset. The computer-based trials are performed in an environment that is isolated from both the data provider and the trial provider. Software-provided access controls, such as identity and access management (JAM) permission checks, prevent either party from any direct access to this environment. All software components in this environment, such as cloud storage and compute services needed to execute the computer-based trials, further have software-provided mechanisms, such as access transparency logs, that trigger alerts and leave a trace to both the trial provider and the data provider for verification when the cloud provider accesses the environment.

Changes to code and/or configurations for the computer-based trials can be made by the trial provider, and reports are generated to evaluate effects and/or implications of the changes. For machine learning based trials, the changes can include a new machine learning model, such as neural networks instead or trees, or different parameters for the same machine learning model. The changes are reviewed to ensure the reports do not reveal non-public data in the dataset. The computer-based trials can include iterative runs using the dataset, each run resulting in the changes based on the generated reports. The data provider can view logs of the computer-based trials using their datasets. The logs can reference reports generated for a specific trial.

For some computer-based trials, such as evaluating a quality of matching entities against a knowledge graph, access to a subset of the raw non-public data can be required. A request is sent by the trial provider to the data provider to generate a report including the non-public data. The data provider can grant permissions to generate such a report. The computer-based trials can then be performed. The trial provider can also generate an error report based on access to the non-public data if a computer-based trial indicates a problem with the non-public data.

Data in the dataset can be redacted automatically when a computer-based trial is started but before being processed further in the computer-based trials. The data can be redacted according to one or more redaction principles. For example, information included in the reports should be minimized, such as raw input data only being included if needed for troubleshooting. As another example, data provider identifiers in the dataset can be artificially-identified, some fields of the dataset can be mapped non-reversibly to random values if the exact value of the field is irrelevant for the computer-based trial, and some values of the dataset can be grouped together if full accuracy is not required. The automatic redaction can result in a new redacted copy of the dataset that is not visible to the data provider, such that the original dataset is not modified. Schema for the data can remain unchanged from the redaction. Datasets from different data providers can be stored separately in a designated environment for redacted datasets.

The computer-based trials using the dataset can include a machine learning pipeline for a training run to generate a machine learning model/output or a machine learning pipeline for an evaluation/backtest run using a model/output generated from a previous computer-based trial. The pipeline can include code and runtime parameters generated by the trial provider for a specific trial and/or the name of the dataset. The computer-based trials can persist output artifacts, such as trained models, which can then be reused by future trials, such as backtest/evaluation runs.

The computer-based trials can be initiated using a dedicated interface that does not require direct access to any resource or data that belongs to a data provider. The dedicated interface can be backed by reports access software that provides limited capabilities to trial providers to start, monitor, and/or cancel computer-based trials without data access. The dedicated interface can also include a command-line client for accessing the trial provider API.

Access logs viewable by the data provider and/or the trial provider can be generated during the computer-based trials. The access logs viewable by the data provider can include a timestamp of access, a name of the dataset used for the computer-based trial, and a reference to the report accessed. The access logs viewable by the trial provider can include the timestamp, name of the dataset, and reports accessed, as well as an identity of the trial provider personnel starting the computer-based trial.

Reports generated by a computer-based trial can be viewed by the trial provider using a dedicated interface that does not have access to the data provider environment, such as a web interface. The interface may grant view-only access while keeping reports in volatile memory. Reports can be grouped by trial and by time within a trial. Reports can be identified by pipeline run start time and by an operation identification. The access logs can be generated each time the trial provider accesses a report. The access logs viewable by the data provider can include a timestamp of access, a name of the dataset used for the computer-based trial that generated the report, and a reference to the report accessed. The access logs viewable by the trial provider can also include the timestamp, name of the dataset, and reports accessed, and an identity of the trial provider personnel accessing the report.

The cloud provider can provide infrastructure to store the reports and/or other outputs of computer-based trials, such as machine learning models, that ensures neither the data provider nor the trial provider has access to the computer-based trial execution environment. The trial execution environment is opaque such that neither the trial provider nor the data provider has access by default. Further, administrative access by the cloud provider can trigger an alert or a log that is visible to the data provider and/or trial provider. The cloud provider can implement additional security provisions such as regionalized storage that is encrypted with encryption keys managed by the data provider and within virtual private cloud service control (VPC-SC) perimeters. When viewing the reports by the data provider or trial provider, the reports are temporarily persisted in a different storage (e.g., volatile memory) and any access to the different storage is logged.

Reports, models, and/or outputs can be stored indefinitely unless required to be deleted due to dataset deletion by a data provider. When the dataset is deleted, all models and/or outputs derived from the dataset are subsequently deleted within a period of time. All reports derived from the deleted dataset are subsequently deleted within a period of time as well. The derived reports can include direct derivation, where the reports are a direct output of a training/backtest run, and/or indirection derivation, where the reports are generated indirectly via a derived model or output.

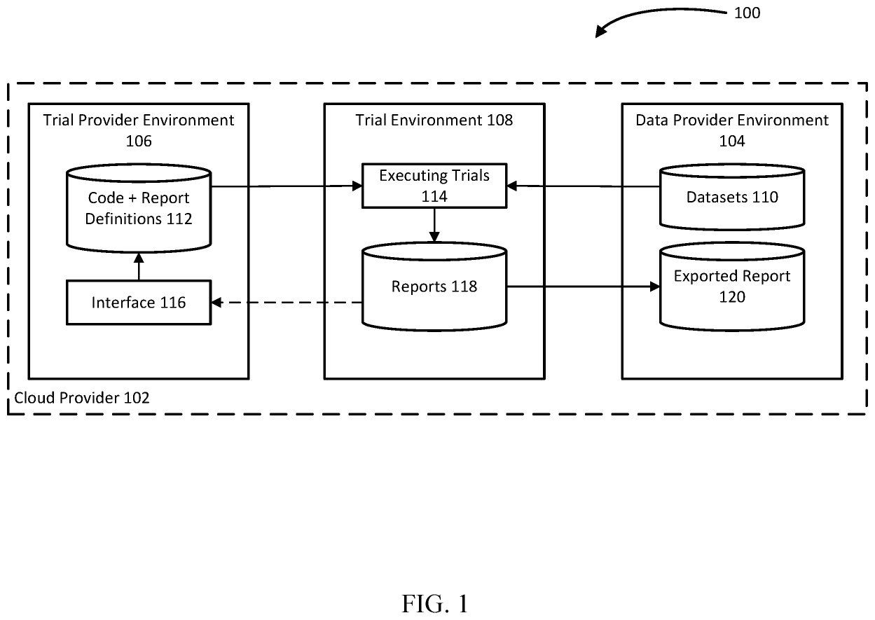

FIG. 1 depicts a block diagram of an example infrastructure 100 for protecting non-public data in computer-based trials. Computer-based trials can include training, validating, and/or optimizing a machine learning model or training, validating, and/or optimizing an algorithm. The machine learning models and/or algorithms can be used for fraud detection or identifying other financial crimes, identifying anomalies in medical scans, tracing patterns on networks, improving shopping recommendations, or optimizing advertising, as examples. Reports can be generated using results of the computer-based trials. The reports can contain performance metrics or other data points to evaluate the computer-based trials. The reports can be viewed without divulging the non-public data.

The infrastructure 100 can include a cloud provider 102 that can correspond to a software as a service (SaaS) platform for providing an environment for executing the computer-based trials and generating reports from the computer-based trials. The cloud provider 102 can also provide an environment for storing source code for the computer-based trials, the non-public data, and the reports generated from the computer-based trials.

The cloud provider 102 can include a data provider environment 104 for a data provider, a trial provider environment 106 for a trial provider, and a computer-based trial environment 108. Data providers can provide the non-public data for running the computer-based trials. Trial providers can initiate runs of and provide code for the computer-based trials that are executed in the computer-based trial environment 108 using the non-public data.

The data provider can use a data provider application programming interface (API) to grant the trial provider access to one or more datasets 110 that include the non-public data. The datasets 110 are transmitted from the data provider environment 104 to the computer-based trial environment 108. The datasets 110 can be updated periodically by the data provider, for example on a regular schedule like daily or weekly or whenever the data provider receives new data. The data provider can later mark the datasets 110 as unavailable for the computer-based trials, which can trigger automatic deletion of the datasets 110 and any derived reports from computer-based trials conducted on the datasets 110.

The trial provider can use a trial provider API and/or trial provider client software to orchestrate and monitor computer-based trials. Source code and report definitions 112 for running the computer-based trials are transmitted from the trial provider environment 106 to the computer-based trial environment 108. Report definitions can include notebooks having tensor flow model analysis metrics or dataset statistics. The source code and report definitions 112 for the computer-based trials can be updated as the computer-based trials are conducted. The updates are reviewed by trial providers to ensure non-public data in the datasets 110 are not revealed by the updates.

The trial provider can execute the computer-based trials 114 in the computer-based trial environment 108 using the datasets 110 based on the source code and report definitions 112. The computer-based trial environment 108 is opaque, such that neither the trial provider nor the data provider has direct access to the computer-based trial environment 108. Any administrative access by the cloud provider 102, such as if an error is detected during the computer-based trials 114, can trigger an alert or generate a log visible to the trial provider and the data provider.

The computer-based trial environment 108 is isolated from both the data provider environment 104 and the trial provider environment 106. Software-provided access controls, such as identity and access management (JAM) permission checks, firewalls, and intrusion detection systems, can prevent the data provider or the trial provider from any direct access to the computer-based trial environment 108. IAM permission checks can include policies to ensure that the data provider, trial provider, and/or cloud provider have appropriate access to their respective environments. Firewalls can establish barriers between the computer-based trial environment 108 and both the data provider environment 104 and trial provider environment 106 to monitor and control incoming and outgoing traffic. Intrusion detection systems can monitor for malicious activity or violations of policies, such as violations of the IAM permission checks.

Any software components in the computer-based trial environment 108, such as cloud storage and/or processors for executing the computer-based trials 114, include software-provided mechanisms that trigger alerts and/or leave a trace when the computer-based trial environment 108 is accessed by the cloud provider. The alerts and/or trace can be provided to the data provider and the trial provider. Software-provided mechanisms can include access transparency logs.

The computer-based trial environment 108 can be enclosed in an isolated unit, container, or sandbox with unique permissions or properties compared to other units, containers, or sandboxes within the cloud provider 102. Having its own unique permissions or properties allows for simple access control as these unique permissions or properties do not need to be repeated for each component running in the isolated unit, container, or sandbox.

The non-public data in the datasets 110 can be redacted automatically when starting a computer-based trial 114. The non-public data can be redacted based on redaction principles, which can be part of the source code and report definitions 112 transmitted from the trial provider environment 106. An example redaction principle can correspond to minimizing information included in reports generated from the computer-based trials 114. For example, raw input data should only be included if needed for troubleshooting. Another example redaction principle can correspond to data provider identifiers in the dataset 110 being artificially-identified. For example, some fields of the dataset 110 can be mapped non-reversibly to random values if the exact value of the field is irrelevant for the computer-based trial. As another example, some fields of the dataset can be grouped together if full accuracy is not required.

Automatic redaction can generate a new redacted copy of the dataset 110 that is not visible to the data provider. The original dataset 110 transmitted to the computer-based trial environment 108 is not modified. Further, schema for the dataset 110 remain unchanged from the redaction. Datasets from different data providers can be stored separately in a designated area in the computer-based trial environment 108 for redacted datasets.

An example computer-based trial 114 executed using the datasets 110 can correspond to a machine learning pipeline for a training run to generate a machine learning model/output or an evaluation/backtest run using a previously generated model/output. The pipeline can include source code and runtime parameters generated by the trial provider for a specific trial. Another example computer-based trial 114 can correspond to an optimization pipeline for generating an algorithm. The pipeline can include processing input data and optimizing an objective function.

The computer-based trials 114 can be initiated using a dedicated interface 116, such as a web interface, in the trial provider environment 106. The dedicated interface 116 does not require direct access to any resource or data that belongs to the data provider. The dedicated interface 116 can be backed by the trial provider API that provides limited capabilities to trial providers to start, monitor, and/or cancel computer-based trials 114 without data access. The dedicated interface 116 can also include a command-line client for accessing the trial provider API.

The dedicated interface 116 can also allow for changes to the source code and/or configurations of the computer-based trials 114. The changes can include a new machine learning model, such as neural networks instead of trees, or different parameters for the same machine learning model. The changes can also include parameters in optimization algorithms, such as choice of the algorithm itself or step size. The trial provider can review the changes through the dedicated interface 116 to ensure the changes do not reveal non-public data from the datasets 110. The computer-based trials 114 can include iterative runs using the datasets 110, where each run results in changes based on the previous run.

For some computer-based trials, such as evaluating a quality of matching entities against a knowledge graph, access to a subset of the raw non-public data can be required. A request can be sent by the trial provider to the data provider to generate a report that includes the non-public data. The data provider can grant permissions to generate such a report. The computer-based trials are then performed. The trial provider can also generate an error report based on access to the non-public data if a computer-based trial indicates a problem with the non-public data.

Reports 118 are generated in the computer-based trial environment 108 using results of the executed computer-based trials 114. The reports 118 can contain performance metrics or other data points to evaluate the computer-based trials 114 and/or changes to the computer-based trials 114. As other examples, the reports 118 can contain a summary of parameters used for the computer-based trials 114, metrics over different slices of the computer-based trials 114, plots of metrics over different ranges, and/or statistics for the dataset itself 110, such as dataset size and/or average values for specific columns of the dataset 110. Reports 118 can be grouped by trial and by time within a trial and can be identified by start time and/or by operation identification.

The reports 118 can be viewed without divulging the non-public data from the datasets 110. The reports 118 can be viewed by the trial provider using the dedicated interface 116. The dedicated interface 116 can grant view-only access to the reports 118, indicated by dashed lines in FIG. 1, while storing the reports in volatile memory. The reports can be viewed by the data provider using the data provider API to export the reports 120 to storage in the data provider environment 104. Using the data provider API, the data provider can provide feedback based on the exported report 120. For example, if the exported report 120 contains observations that are unexpected, the data provider can give context or explanation to better understand the unexpected observation.

During or after the computer-based trials 114, access logs can be generated that are viewable by the data provider and/or the trial provider. The access logs viewable by the data provider can include a timestamp of access, a name of the dataset used for the computer-based trial, and a reference to the report accessed, as examples. The access logs viewable by the trial provider can include the timestamp, name of the dataset, and reports accessed, as well as an identity of the trial provider personnel starting the computer-based trial, as examples. The access logs can be generated each time the trial provider accesses a report.

The cloud provider 102 can store the reports, models, and/or outputs from the computer-based trials 114 in the computer-based trial environment 108 such that neither the data provider nor the trial provider has access. The cloud provider 102 can implement additional security provisions such as regionalized storage that is encrypted with encryption keys managed by the data provider and within virtual private cloud service control (VPC-SC) perimeters. When viewing the reports by the trial provider, the reports are temporarily persisted in a different storage, such as volatile memory, and any access to the different storage is logged.

Reports, models, and/or outputs can be stored indefinitely in the computer-based trial environment 108 unless required to be deleted as a result of dataset 110 deletion by the data provider. When the dataset 110 is deleted, all models and/or outputs derived from the dataset 110 are subsequently deleted within a period of time. All reports 118 derived from the deleted dataset are subsequently deleted within a period of time as well. The derived reports can include direct derivation, where the reports are a direct input of a machine learning training or validation run, and/or indirection derivation, where the reports are used indirectly via a derived model or output. The exported reports 120 can be deleted as well or kept by the data provider.

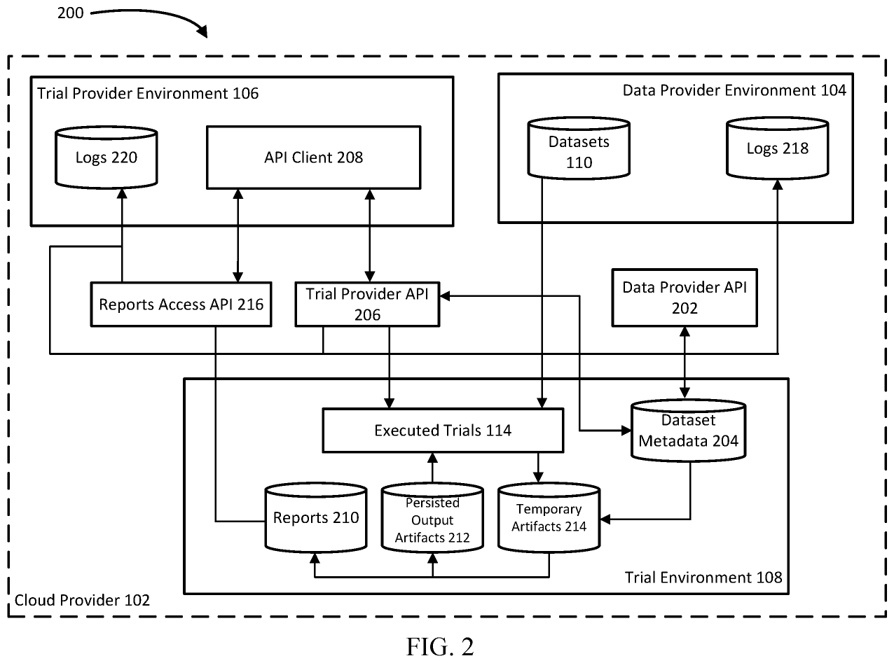

FIG. 2 depicts a block diagram further detailing an example infrastructure 200 for the data provider environment 104, trial provider environment 106, and computer-based trial environment 108 of the cloud provider 102.

The cloud provider 102 can include a data provider API 202 to allow the data provider to grant the trial provider access to the datasets 110 in the data provider environment 104. The data provider API 202 can also be used to periodically update access to the datasets 110, for example, what datasets of the data provider are being granted access. The data provider API 202 can also allow the data provider to mark the datasets 110 as unavailable for the computer-based trials, which can trigger an automatic deletion of the datasets 110 as well as any reports from the computer-based trials derived from the datasets 110. Based on what dataset access is granted through the data provider API 202, metadata 204 for the datasets 110 can be stored in storage in the computer-based trial environment 108. The metadata 204 can include information on types of data in the datasets as well as which datasets have been marked as available and/or unavailable by the data provider.

The cloud provider 102 can include a trial provider API 206 and/or other trial provider client software to manage the computer-based trials 114 using the datasets 110. The trial provider API 206 can allow for transmitting source code and report definitions for running the computer-based trials 114 to the computer-based trial environment 108. The trial provider API 206 can also be configured to update the source code and report definitions for the computer-based trials 114 to transmit to the computer-based trial environment 108. Any updates to the source code and/or report definitions are reviewed by trial providers to ensure non-public data in the datasets 110 are not revealed by the updates.

The trial provider API 206 can back an API client 208. This API client 208 can be part of the dedicated interface 116 as depicted in FIG. 1, which may include other components, such as a proxy or web interface, for initiating, monitoring, and/or canceling the computer-based trials 114. The API client 208 can be used to initiate, monitor, and/or cancel the computer-based trials 114 without accessing any resource or dataset of the data provider. The API client 208 can also include a command-line client for accessing the trial provider API 206. The API client 208 can be used by the trial provider to change source code and/or configurations of the computer-based trials 114. The API client 208 can also be used by the trial provider to review the changes to ensure the changes do not reveal non-public data from the datasets 110. If a computer-based trial requires access to a subset of the non-public data or there is an error with running the computer-based trials, the API client 208 can be used to send a request by the trial provider to the data provider to generate a report that can include the subset of non-public data.

The trial provider API 206 can be configured to allow the trial provider to execute the computer-based trials 114 in the computer-based trial environment 108 with the datasets 110. To maintain isolation in the computer-based trial environment 108, the cloud provider 102 can include access controls to prevent the trial provider and/or data provider from direct access to the computer-based trial environment 108. Further, any software components in the computer-based trial environment 108, such as cloud storage for reports 210, persisted output artifacts such as models 212, and/or temporary artifacts 214 and processors for executing the computer-based trials 114, can include soft-provided mechanisms to trigger alerts and/or leave a trace when a respective software component is accessed. The reports 210 can correspond to the reports 118 as depicted in the infrastructure 110 of FIG. 1. The computer-based trials can persist output artifacts, such as trained models, which can then be reused by future trials, such as backtest/evaluation runs. The alerts and/or trace can be provided to the trial provider and/or data provider via the trial provider API 206.

The reports 210, persisted output artifacts 212, and temporary artifacts 214 can be stored separately to provide additional security. This can be to ensure reports 210 are not retrieved with other artifacts 212, 214. Therefore, even if a glitch or bug caused attempted access to the artifacts 212, 214 via retrieving reports 210, internal permissions would prevent such access. The storage for the temporary artifacts 214 can be configured to automatically delete objects after a period of time, such as 30 days.

The trial provider API 206 can further allow for automatically redacting non-public data in the datasets 110 when initiating a computer-based trial 114. The trial provider API 206 can provide for redaction principles to redact the non-public data to generate redacted datasets. The redaction principles can be included in the source code and report definitions being transmitted to the computer-based trial environment 108, such that redaction can occur via a software component in the computer-based trial environment 108. The automatic redaction can generate a new redacted copy of the dataset that is stored in the computer-based trial environment 108, so as not to be visible to the data provider.

For the example computer-based trial corresponding to generating a machine learning model and/or validating a generated machine learning model, the computer-based trial environment 108 can include software for executing the computer-based trials 114 to train and/or validate a machine learning model.

The computer-based trial environment 108 can also include storage for storing the persisted output artifacts 212, temporary artifacts 214, and reports 210 for evaluating the computer-based trials 114. When viewing the reports 210 by the trial provider, the reports 210 are temporarily persisted in a different storage, such as volatile memory, and any access to the different storage is logged. When the dataset 110 is deleted, all artifacts 212, 214 derived from the dataset 110 are subsequently deleted within a period of time. All reports 210 derived from the deleted dataset are subsequently deleted within a period of time as well.

The computer-based trial environment 108 can include additional security provisions such as regionalized storage that is encrypted with encryption keys managed by the data provider and within VPC-SC perimeters.

The computer-based trials 114 can generate the reports 210 from the results of the computer-based trials 114. The reports 210 can contain performance metrics or other data points to evaluate the computer-based trials 114 and/or changes to the computer-based trials 114. The reports 210 can be grouped by trial and by time within a trial and can be identified by start time and/or by a unique identifier generated for each trial run.

Using the API client 208 backed by a reports access API 216, the reports 210 can be viewed without revealing the non-public data from the datasets 110. The reports access API 216 can allow the trial provider to view the reports 210 using the API client 208 by granting view-only access to the reports 210 and temporarily storing the reports 210 in volatile memory separate from the storage in the computer-based trial environment 108.

The reports access API 216 can also allow the data provider to view the reports 210. The reports access 216 can export the reports 210 to storage in the data provider environment 104. The data provider can give feedback about the computer-based trials 114 based on the reports 210 using the data provider API.

The reports access API 216 can generate access logs 218, 220 that are viewable by the data provider and trial provider, respectively. The access logs 218 viewable by the data provider can include a timestamp of access, a name of the dataset used for the computer-based trial, and a reference to the report accessed, as examples. The access logs 220 viewable by the trial provider can include the timestamp, name of the dataset, and reports accessed, as well as the trial provider personnel starting the computer-based trial, as examples. The reports access 216 can generate the access logs 218, 220 each time the trial provider accesses the reports 210.

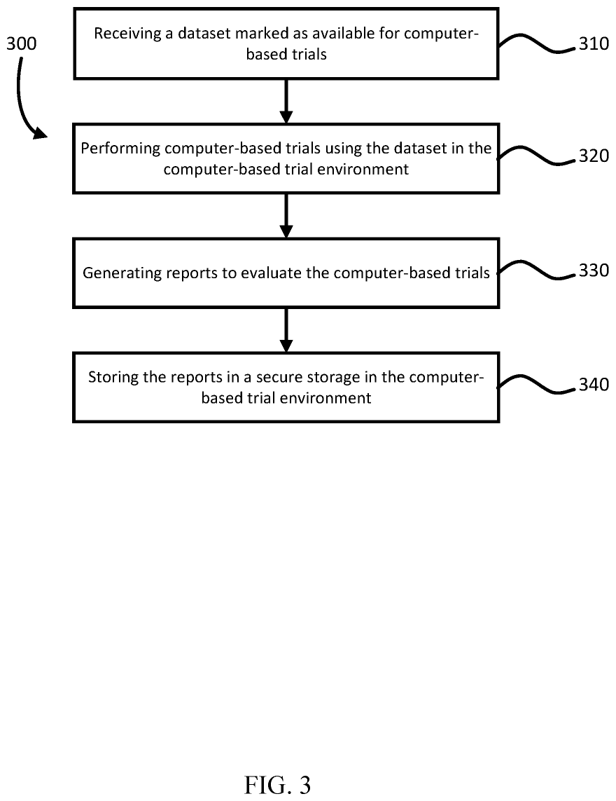

FIG. 3 depicts a flow diagram of an example process 300 for protecting non-public data in computer-based trials. The process 300 can be performed by a system of one or more processors located in one or more locations. For example, software provided by the cloud provider 102 as depicted in FIG. 1, can perform the process 300.

As shown in block 310, software provided by the cloud provider 102, such as one or more processors, can receive a dataset from a data provider that is marked as available for the computer-based trials. The dataset can include non-public data. The dataset can be received in a compute environment, such as the computer-based trial environment 108, that is isolated from the data provider and the trial provider.

The compute environment is isolated from the data provider and trial provider via software-provided access controls to prevent direct access to the compute environment. Further, any software components in the compute environment, such as cloud storage and/or processors for executing the computer-based trials, include software-provided mechanisms that trigger alerts and/or leave a trace when the computer-based trial environment is accessed. The alerts and/or trace can be provided to the data provider and the trial provider. Software-provided mechanisms can include access transparency logs.

As shown in block 320, the software provided by the cloud provider 102 can perform one or more computer-based trials using the dataset in the isolated compute environment. An example computer-based trial executed using the datasets can correspond to a machine learning pipeline for a training run to generate a machine learning model/output or an evaluation/backtest run using a previously generated model/output. The pipeline can include source code and runtime parameters generated by the trial provider for a specific trial.

As shown in block 330, the software provided by the cloud provider 102 can generate one or more reports in the isolated compute environment based on the performed computer-based trials to evaluate the computer-based trials. The reports can contain performance metrics or other data points to evaluate the computer-based trials and/or changes to the computer-based trials.

As shown in block 340, the software provided by the cloud provider 102 can store the generated reports in a secure storage in the isolated compute environment. The secure storage is inaccessible to the trial provider and the data provider and any access to the secure storage by the cloud provider can be provided to the trial provider and/or the data provider. The secure storage can be regionalized storage that is encrypted with encryption keys managed by the data provider. The secure storage can also be within VPC-SC perimeters. The generated reports can be viewed by the trial provider by retrieving the reports through a dedicated report access service and then temporarily storing the reports in volatile memory separate from the secure storage. The generated reports can be viewed by the data provider by exporting the reports to separate storage for the data provider. Any viewing of the generated reports can create access logs viewable by the data provider and access logs viewable by the trial provider.

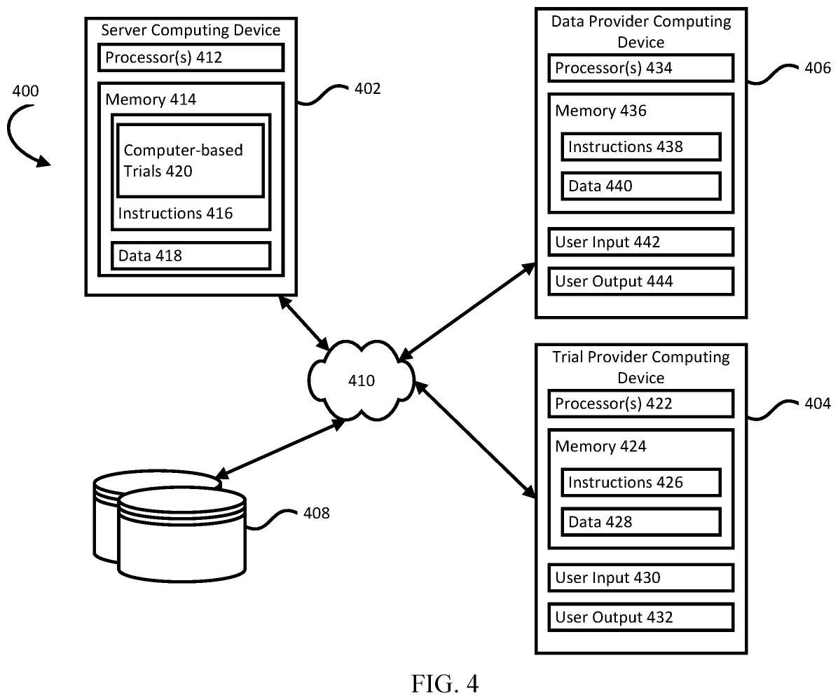

FIG. 4 depicts a block diagram of an example environment 400 for implementing a system for protecting non-public data in computer-based trials. The system can be implemented on one or more devices having one or more processors in one or more locations, such as in server computing device 402, trial provider computing device 404, and data provider computing devices 406. The computing devices 402, 404, and 406 can be communicatively coupled to one or more storage devices 408 over a network 410. The storage devices 408 can be a combination of volatile and non-volatile memory and can be at the same or different physical locations than the computing devices 402, 404, 406. For example, the storage devices 408 can include any type of non-transitory computer readable medium capable of storing information, such as a hard-drive, solid state drive, tape drive, optical storage, memory card, ROM, RAM, DVD, CD-ROM, write-capable, and read-only memories. The storage devices 408 can correspond to the secure storage in the computer-based trial environment as previously depicted.

The server computing device 402 can include one or more processors 412 and memory 414. The memory 414 can store information accessible by the processors 412, including instructions 416 that can be executed by the processors 412. The memory 414 can also include data 418 that can be retrieved, manipulated, or stored by the processors 412. The memory 414 can be a type of non-transitory computer readable medium capable of storing information accessible by the processors 412, such as volatile and non-volatile memory. The processors 412 can include one or more central processing units (CPUs), graphic processing units (GPUs), field-programmable gate arrays (FPGAs), and/or application-specific integrated circuits (ASICs), such as tensor processing units (TPUs).

The instructions 416 can include one or more instructions that when executed by the processors 412, causes the one or more processors to perform actions defined by the instructions. The instructions 416 can be stored in object code format for direct processing by the processors 412, or in other formats including interpretable scripts or collections of independent source code modules that are interpreted on demand or compiled in advance. The instructions 416 can include instructions for executing the computer-based trials 420 with non-public data. The instructions for the computer-based trials 420 can be executed using the processors 412, and/or using other processors remotely located from the server computing device 402.

The data 418 can be retrieved, stored, or modified by the processors 412 in accordance with the instructions 416. The data 418 can be stored in computer registers, in a relational or non-relational database as a table having a plurality of different fields and records, or as JSON, YAML, proto, or XML documents. The data 418 can also be formatted in a computer-readable format such as, but not limited to, binary values, ASCII or Unicode. Moreover, the data 418 can include information sufficient to identify relevant information, such as numbers, descriptive text, proprietary codes, pointers, references to data stored in other memories, including other network locations, or information that is used by a function to calculate relevant data.

The server computing device 402 can be isolated from the trial provider computing device 404 and data provider computing device 406 as previously described to conduct the computer-based trials with the non-public data.

The trial provider computing device 404 can be configured similarly to the server computing device 402, with one or more processors 422, memory 424, instructions 426, and data 428. The trial provider computing device 404 can include a user input 430 and a user output 432. The user input 430 can include any appropriate mechanism or technique for receiving input from a user, such as keyboard, mouse, mechanical actuators, soft actuators, touchscreens, microphones, and sensors.

The server computing device 402 can be configured to transmit data to the trial provider computing device 404, and the trial provider computing device 404 can be configured to display at least a portion of the received data on a display implemented as part of the user output 432. The user output 432 can also be used for displaying an interface between the trial provider computing device 404 and the server computing device 402. The user output 432 can alternatively or additionally include one or more speakers, transducers or other audio outputs, a haptic interface or other tactile feedback that provides non-visual and non-audible information to the trial provider using the trial provider computing device 404.

The data provider computing device 406 can also be configured similarly to the trial provider computing device 404, with one or more processors 434, memory 436, instructions 438, data 440, user input 442, and user output 444.

Although FIG. 4 illustrates the processors 412, 422, 434 and the memories 414, 424, 434 as being within the computing devices 402, 404, 406, components described herein can include multiple processors and memories that can operate in different physical locations and not within the same computing device. For example, some of the instructions 416, 426, 438 and the data 418, 428, 440 can be stored on a removable SD card and others within a read-only computer chip. Some or all of the instructions and data can be stored in a location physically remote from, yet still accessible by, the processors 412, 422, 434. Similarly, the processors 412, 422, 434 can include a collection of processors that can perform concurrent and/or sequential operation. The computing devices 402, 404, 406 can each include one or more internal clocks providing timing information, which can be used for time measurement for operations and programs run by the computing devices 402, 404, 406.

The computing devices 402, 404, 406 can be capable of direct and/or indirect communication over the network 410. For example, using a network socket, the trial provider computing device 404 and data provider computing device 406 can connect to the server computing device 402 through an Internet protocol. The computing devices 402, 404, 406 can set up listening sockets that may accept an initiating connection for sending and receiving information. The network 410 itself can include various configurations and protocols including the Internet, World Wide Web, intranets, virtual private networks, wide area networks, local networks, and private networks using communication protocols proprietary to one or more companies. The network 410 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 410, in addition or alternatively, can also support wired connections between the computing devices 402, 404, 406, including over various types of Ethernet connection.

Although a single server computing device 402, trial provider computing device 404, and data provider computing device 406 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing neural networks, and any combination thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for protecting data in computer-based trials comprising:
receiving from a data provider, with one or more processors of a cloud provider, a dataset marked as available for the computer-based trials;
performing by a trial provider, with the one or more processors, one or more computer-based trials using the dataset in a compute environment that is isolated from the trial provider and the data provider;
generating, with the one or more processors, one or more reports based on the performed computer-based trials to evaluate the computer-based trials; and
storing, with the one or more processors, the one or more reports in a secure storage that is inaccessible to the trial provider and the data provider, wherein access to the data by the cloud provider is verified by at least one of the trial provider or the data provider.

2. The method of claim 1, further comprising deleting, with the one or more processors, the one or more reports from the secure storage within a period of time when the dataset marked as available for the computer-based trials is deleted.

3. The method of claim 1, further comprising automatically redacting, with the one or more processors, data in the dataset to generate a redacted dataset, wherein the one or more computer-based trials are performed using the redacted dataset to generate the reports.

4. The method of claim 3, wherein the redacted dataset comprises at least one of irreversible mapping of fields of the dataset to random values or bucketizing fields of the dataset.

5. The method of claim 3, wherein the redacted dataset is a new copy of the dataset marked as available for the computer-based trials.

6. The method of claim 1, wherein performing the one or more computer-based trials further comprises running a machine learning pipeline for a training run or a validation run.

7. The method of claim 1, further comprising logging, with the one or more processors, each view of the one or more reports by the data provider or the trial provider.

8. The method of claim 7, wherein logging each view of the one or more reports further comprises generating an access log for at least one of the data provider or the trial provider.

9. A system comprising:
one or more processors; and
one or more storage devices coupled to the one or more processors and storing instructions that, when executed by the one or more processors, cause the one or more processors to perform operations for protecting data in computer-based trials, the operations comprising:
receiving a dataset marked as available for the computer-based trials;
performing one or more computer-based trials using the dataset in an isolated compute environment;
generating one or more reports based on the performed computer-based trials to evaluate the computer-based trials; and
storing the one or more reports in a secure storage, wherein access to the secure storage is verifiable.

10. The system of claim 9, wherein the operations further comprise deleting the one or more reports from the secure storage within a period of time when the dataset marked as available for the computer-based trials is deleted.

11. The system of claim 9, wherein the operations further comprise automatically redacting data in the dataset to generate a redacted dataset, wherein the one or more computer-based trials are performed using the redacted dataset to generate the reports.

12. The system of claim 11, wherein the redacted dataset is a new copy of the dataset marked as available for the computer-based trials.

13. The system of claim 9, wherein performing the one or more computer-based trials further comprises running a machine learning pipeline for a training run or a validation run.

14. The system of claim 9, wherein the operations further comprise logging each view of the one or more reports.

15. The system of claim 14, wherein logging each view of the one or more reports further comprises generating an access log.

16. A non-transitory computer readable medium for storing instructions that, when executed by one or more processors, cause the one or more processors to perform operations for protecting data in computer-based trials, the operations comprising:
receiving a dataset marked as available for the computer-based trials;
performing one or more computer-based trials using the dataset in an isolated compute environment;
generating one or more reports based on the performed computer-based trials to evaluate the computer-based trials; and
storing the one or more reports in a secure storage, wherein access to the secure storage is verifiable.

17. The non-transitory computer readable medium of claim 16, wherein the operations further comprise deleting the one or more reports from the secure storage within a period of time when the dataset marked as available for the computer-based trials is deleted.

18. The non-transitory computer readable medium of claim 16, wherein the operations further comprise automatically redacting data in the dataset to generate a redacted dataset, wherein the one or more computer-based trials are performed using the redacted dataset to generate the reports.

19. The non-transitory computer readable medium of claim 16, wherein performing the one or more computer-based trials further comprises running a machine learning pipeline for a training run or a validation run.

20. The non-transitory computer readable medium of claim 16, wherein the operations further comprise logging each view of the one or more reports by generating an access log.
